(19) United States
(12) Patent Application Publication
(10) Pub. No.: US 2024/0214986 A1
(43) Pub. Date: Jun. 27, 2024

(54) INFORMATION PROCESSING METHOD AND APPARATUS, COMMUNICATION DEVICE, AND STORAGE MEDIUM

(71) Applicant: BEIJING XIAOMI MOBILE SOFTWARE CO., LTD., Beijing (CN)

(72) Inventor: Yanhua LI, Beijing (CN)

(73) Assignee: BEIJING XIAOMI MOBILE SOFTWARE CO., LTD., Beijing (CN)

(21) Appl. No.: 18/288,990

(22) PCT Filed: Apr. 29, 2021
(86) PCT No.: PCT/CN2021/091191

§ 371 Date: Oct. 30, 2023

(51) Int. Cl. H04W 68/02

(52) U.S. Cl. CPC H04W 68/02

(57) ABSTRACT

An information processing method includes performing, between an access network device and a core network device, transmission of paging auxiliary information for paging a user equipment (UE).

### CROSS-REFERENCE TO RELATED APPLICATION

The present application is the U.S. National Stage of International Application No. PCT/CN2021/091191, filed on Apr. 29, 2021, the disclosure of which is incorporated herein by reference in its entirety for all purposes.

### BACKGROUND

According to the connection relationship between the user equipment (UE) and the network side, the state of the UE can be categorized into a radio resource control (RRC) connected state (referred to as connected state) and a non-connected state. The non-connected state includes an idle state that is visible to the core network device at the network side, and an inactive state that is only visible to the access network, i.e., not visible to the core network (CN) device.

### SUMMARY

The present disclosure relates to the field of wireless communication technologies, and in particular to an information processing method and apparatus, a communication device, and a storage medium. Embodiments of the present disclosure provide an information processing method and apparatus, a communication device, and a storage medium.

According to a first aspect of the present disclosure, some embodiments provide an information processing method. The method is performed by an access network device and includes performing, between the access network device and a core network device, transmission of paging auxiliary information for paging a user equipment (UE). The paging auxiliary information is used for paging the UE.

According to a second aspect of the present disclosure, some embodiments provide an information processing method. The method is performed by a core network device and includes performing, between the core network device and an access network device, transmission of paging auxiliary information for paging a UE. The paging auxiliary information is used for paging the UE.

According to a third aspect of the present disclosure, some embodiments provide a communication device. The communication device includes a processor, a transceiver, a memory, and an executable program stored in the memory and capable of being executed by the processor. The processor, through executing the executable program, performs the information processing method according to the first aspect or the second aspect.

According to a fourth aspect of the present disclosure, some embodiments provide a computer storage medium. The storage medium stores an executable program. The executable program, through being executed by a processor, is capable of implementing the information processing method according to the first aspect or the second aspect.

It should be understood that the above general description and the subsequent detailed description are only exemplary and explanatory, and do not limit the embodiments of the present disclosure.

### BRIEF DESCRIPTION OF THE DRAWINGS

The accompanying drawings herein, which are incorporated into and form a part of the specification, illustrate the embodiments consistent with the present disclosure and are used in conjunction with the specification to explain the principles of the embodiments of the present invention.

FIG. 1 is a schematic structural diagram of a wireless communication system illustrated according to an embodiment of the present disclosure;

FIG. 2A is a flowchart of an information processing method illustrated according to an embodiment of the present disclosure;

FIG. 2B is a flowchart of an information processing method illustrated according to an embodiment of the present disclosure;

FIG. 2C is a flowchart of an information processing method illustrated according to an embodiment of the present disclosure;

FIG. 3A is a flowchart of an information processing method illustrated according to an embodiment of the present disclosure;

FIG. 3B is a flowchart of an information processing method illustrated according to an embodiment of the present disclosure;

FIG. 3C is a flowchart of an information processing method illustrated according to an embodiment of the present disclosure;

FIG. 4 is a schematic structural diagram of an information processing apparatus illustrated according to an embodiment of the present disclosure;

FIG. 5 is a schematic structural diagram of an information processing apparatus illustrated according to an embodiment of the present disclosure;

FIG. 6 is a schematic structural diagram of a communication device illustrated according to an embodiment of the present disclosure.

### DETAILED DESCRIPTION

The embodiments are described herein in detail, examples of which are represented in the accompanying drawings. When the following description relates to the accompanying drawings, the same numerals in the different accompanying drawings indicate the same or similar elements unless otherwise indicated. The implementations described in the following embodiments do not represent all implementations consistent with the embodiments of the present invention. Rather, they are only examples of apparatus and methods consistent with some aspects of the embodiments of the present invention as detailed in the appended claims.

The terms used in the embodiments of the present disclosure is used only for the purpose of describing particular embodiments and are not intended to limit the embodiments of the present disclosure. The singular forms of “a”, “the”, and “this” used in the embodiments of the present disclosure and in the appended claims are also intended to include the majority form, unless the context clearly indicates other meaning. It should also be understood that the term “and/or” as used herein refers to and includes any or all possible combinations of one or more of the associated listed items.

It should be understood that while the terms first, second, third, etc. may be used in the embodiments of the present disclosure to describe various pieces of information, such information should not be limited to these terms. These terms are only used to distinguish the same type of information from one another. For example, without departing from the scope of the embodiments of the present disclosure, the first information may also be referred to as the second information, and similarly, the second information may be referred to as the first information. Depending on the context, the phrase “if” as used herein may be interpreted as “at . . . ”, “when . . . ” or “in response to determining”.

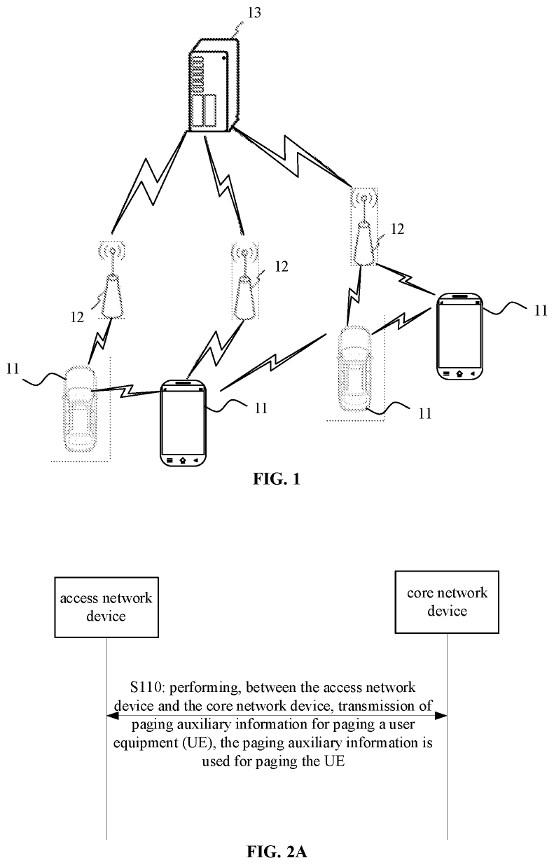

If the UE is currently in the idle state, but there is the UE communicating, the network side may perform CN paging. If the UE is currently in the inactive state, the UE needs to be woken up for communication, the access network may similarly issue radio access network (RAN) paging. The UE monitors the paging message in the paging occasion (PO), thus exiting the non-connected state and entering the connected state. After the access network device receives the paging instruction from the core network device, it sends a paging message to the UE. There is some information that can be used to assist the paging process. Referring to FIG. 1, a schematic structural diagram of a wireless communication system provided by an embodiment of the present disclosure is shown. As shown in FIG. 1, the wireless communication system is a communication system based on a cellular mobile communication technology, and the wireless communication system may include a plurality of UEs 11 and a plurality of access devices 12.

The UE 11 may be a device that provides voice and/or data connectivity to a user. The UE 11 may communicate with one or more core network devices via a radio access network (RAN). The UE 11 may be an internet of things (IOT) UE, such as a sensor device, a mobile phone (or a device known as a “cellular” phone), and a computer having an IoT UE, for example, the UE 11 may be a stationary, portable, pocket-sized, handheld, computer-built, or in-vehicle device. For example, the UE 11 may be a station (STA), a subscriber unit, a subscriber station, a mobile station, a mobile, a remote station, an access point, a remote UE (remote terminal), an access UE (access terminal), a user terminal, a user agent, a user device, or a user equipment (UE). Alternatively, the UE 11 may be an unmanned aerial vehicle (UAV) device. Alternatively, the UE 11 may be an in-vehicle device, such as a traveling computer with wireless communication capabilities, or a wireless communication device that is external to the traveling computer. Alternatively, the UE 11 may be a roadside device, e.g., it may be a street light, a signal light, or other roadside device having wireless communication capabilities.

The access device 12 may be a network side device in the wireless communication system. The wireless communication system may be the 4th generation mobile communication (4G) system, also known as the long term evolution (LTE) system; or, the wireless communication system may also be the 5G system, also known as the new radio (NR) system or 5G NR system. Alternatively, the wireless communication system may be a next generation system of the 5G system. In this case, the access network in the 5G system may be called the new generation-radio access network (NG-RAN). Alternatively, the wireless communication system may be an MTC system.

The access device 12 may be an evolved access device (eNB) used in the 4G system. Alternatively, the access device 12 may be an access device (gNB) using a centralized distributed architecture in the 5G system. When the access device 12 uses the centralized distributed architecture, it usually includes a centralized unit (CU) and at least two distributed units (DUs). The centralized unit is provided with protocol stacks of a packet data convergence protocol (PDCP) layer, a radio link control (RLC) layer, and a media access control (MAC) layer; the distributed unit is provided with protocol stacks for a physical (PHY) layer. The embodiments of the present disclosure do not limit the specific realization of the access device 12.

A wireless connection may be established between the access device 12 and the UE 11 via a wireless air interface. In various embodiments, the wireless air interface is a wireless air interface based on a fourth generation mobile communication network technology (4G) standard; alternatively, the wireless air interface is a wireless air interface based on a fifth generation mobile communication network technology (5G) standard, for example, the wireless air interface is a new air interface; alternatively, the wireless air interface may be a wireless air interface based on a next generation mobile communication network technology standard based on 5G.

In some embodiments, an end to end (E2E) connection may also be established between the UEs 11. Examples include the vehicle to vehicle (V2V) communication, vehicle to infrastructure (V2I) communication, and vehicle to pedestrian (V2P) communication in the vehicle to everything (V2X) communication and other scenarios.

In some embodiments, the wireless communication system described above may further include a network management device 13.

One or more access devices 12 are each connected to the network management device 13. The network management device 13 may be a core network device in the wireless communication system. For example, the network management device 13 may be a mobility management entity (MME) in the evolved packet core (EPC). Alternatively, the network management device may be other core network devices such as a serving gateway (SGW), a public data network gateway (PGW), a policy and charging rules function unit (PCRF), or a home subscriber server (HSS). The embodiments of the present disclosure do not limit the realization form of the network management device 13.

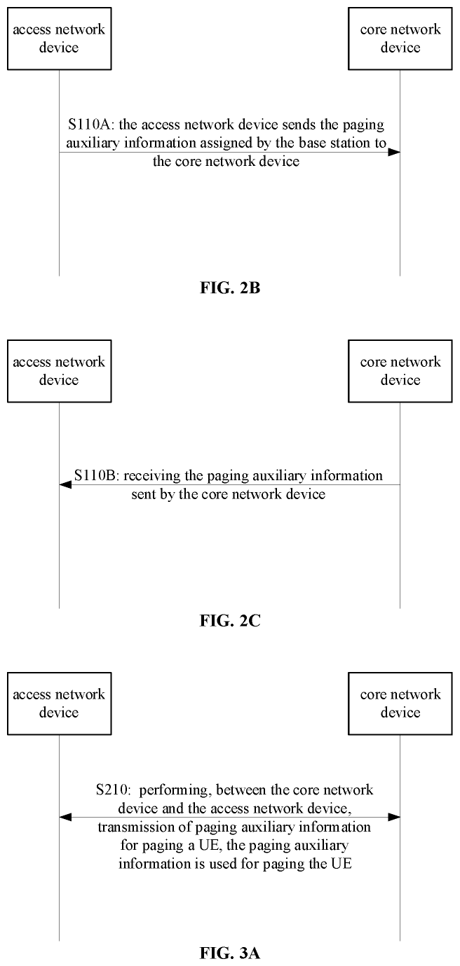

As shown in FIGS. 2A to 2C, an embodiment of the present disclosure provides an information processing method. The method is performed by an access network device, and includes the following step S110.

At step S110, transmission of paging auxiliary information for paging a user equipment (UE) is performed between the access network device and a core network device. The paging auxiliary information is used for paging the UE.

In an embodiment of the present disclosure, the access network device may interact with the core network device for the paging auxiliary information. The paging auxiliary information may be used for paging the UE, for example at least for paging the UE in an inactive state.

For example, the access network device interacts with the core network device for the paging auxiliary information. The core network device includes, but is not limited to, an access management function (AMF).

As shown in FIGS. 2B and 2C, the step S110 may include at least one of the following steps S110A and S110B.

At step S110A, the paging auxiliary information assigned by the access network device is sent by the access network device to the core network device.

At step S110B, the paging auxiliary information sent by the core network device is received by the access network device.

The access network device sends to the core network device the paging auxiliary information assigned by the access network device, which is equivalent to realizing the reporting of the paging auxiliary information assigned by the access network device.

For example, the access network device receives the paging auxiliary information from the core network device. The paging auxiliary information may be assigned by the core network device or reported by the access network device. The paging auxiliary information received from the core network device may be used for the access network device to page the UE in the inactive state and/or the UE in the idle state.

In some embodiments, the paging auxiliary information includes at least one of auxiliary information for paging a UE in an inactive state, or auxiliary information for paging a UE in an idle state.

For example, the access network device reports to the core network device the auxiliary information of its own assigned for paging the UE in the inactive state; the core network device sends to the access network device the auxiliary information of its own assigned for paging the UE in the idle state; or, the core network device sends to the access network device the auxiliary information of its own assigned for paging the UE in the inactive state.

For example, the paging auxiliary information includes at least one of:
paging group information assigned for a UE in an inactive state, where the paging group information is used for a paging group in which the UE monitors a paging message; or
paging period information assigned for the UE in the inactive state, where the paging period information is at least used for indicating a paging frame for the UE in the inactive state to monitor the paging message.

The paging group, for the UE to monitor the paging message, indicated by the paging group information is equivalent to the paging group for the access network device to send the paging message in the PO.

The paging period may include a paging period in a discontinuous reception (DRX) mode and/or a paging period in an extended DRX (eDRX) mode.

For example, the paging period information assigned for the UE in the inactive state is at least used for indicating the paging frame for the UE in the inactive state to monitor the paging message.

Of course, in other embodiments, the paging auxiliary information may further include paging period information for paging the UE in the idle state sent by the core network device to the access network device.

In some embodiments, the paging group information includes at least one of a group identification, a paging probability value or a paging probability level.

The group identification is used for indicating a paging group in which the UE is located.

The paging probability value corresponds to a paging group.

The paging probability level corresponds to a paging group.

The group identification is the group identification that directly identifies the paging group.

If the paging group information carries the group identification, the UE determines the paging group in which the UE itself is located directly based on the group identification, and then monitors the paging messages in the corresponding paging group.

The value range of the paging probability value may be any value between 0 and 1, and the paging probability value corresponds to a paging group, so that if the paging group information is a paging probability value, the UE receives the paging probability value and then monitors the paging message based on the paging group corresponding to the paging probability value.

In other embodiments, the paging group information may be a probability level. For example, the paging probability values between 0 and 1 are divided into a plurality of paging probability value intervals, and different paging probability value intervals correspond to different paging probability levels, so that after the UE receives the paging probability level, the UE determines the paging group in which the UE is located according to the correspondence between the paging probability level and the paging group, and then monitors the paging message in the corresponding paging group in the PO.

For example, the paging probability levels may be at least two. For another example, the paging probability levels may be two, three, or four, and so on.

In some embodiments, the paging group information includes at least one of paging group information indicative of a paging group for a UE in an idle state to transmit a paging message, or paging group information indicative of a paging group for the UE in the inactive state to transmit a paging message.

For example, the paging group information indicative of a paging group for the UE in the idle state to transmit a paging message and the paging group information indicative of a paging group for the UE in the inactive state to transmit a paging message may point to the same paging group or may point to different paging groups.

In summary, in the embodiments of the present disclosure, in order to realize independent control of paging monitoring of the UE in the idle state and the UE in the inactive state, in the embodiments of the present disclosure, the idle state UE (i.e., UE in the idle state) may be provided with a paging group, and the inactive state UE (i.e., UE in the inactive state) may be provided with a paging group, respectively. For example, the paging groups are set based on the paging probability values when the UE is in the idle state and the inactive state, respectively. The paging probability values of the UE in the idle state and in the inactive state may be the same or different.

In some embodiments, both the paging group information indicative of a paging group for the UE in the idle state to transmit a paging message and the paging group information indicative of a paging group for the UE in the inactive state to transmit a paging message may be assigned by the core network device, or both the paging group information indicative of a paging group for the UE in the idle state to transmit a paging message and the paging group information indicative of a paging group for the UE in the inactive state to transmit a paging message may be assigned by the access network device. Alternatively, the paging group information indicative of a paging group for the UE in the idle state to transmit a paging message may be assigned by the core network device, and the paging group information indicative of a paging group for the UE in the inactive state to transmit a paging message may be assigned by the access network device.

In some embodiments, sending to the core network device the paging auxiliary information for paging the UE includes at least one of:
sending the paging auxiliary information to the core network device via a radio connection control inactive state transition request message;
sending the paging auxiliary information to the core network device via an initial context setup response message;
sending the paging auxiliary information to the core network device via a UE context modification response message;
sending the paging auxiliary information to the core network device via a UE context modification indication message;
sending the paging auxiliary information to the core network device via a UE context suspend request message;
sending the paging auxiliary information to the core network device via a retrieve UE information message;
sending the paging auxiliary information to the core network device via a handover request acknowledge message;
sending the paging auxiliary information to the core network device via a path switch request message; or
sending the paging auxiliary information to the core network device via a dedicated message.

In addition to the messages listed above, there may be other existing messages sent by the access network device to the core network device, which will not be enumerated one by one.

The radio connection control inactive state transition request message herein is a radio resource control (RRC) inactive transition report message.

The above initial context setup response message, UE context modification response message, context suspend request message, handover request acknowledge message, and path switch request message are all messages used for and related to UE context processing, cell handover and/or path switching in the related arts. Carrying the paging auxiliary information via these messages may be done without adding new messages, which has the characteristic of good compatibility. In addition to the above listed messages, there may be other existing messages sent by the access network device to the core network device, which will not be enumerated one by one.

The dedicated message herein may be a newly added message. The dedicated message may be understood as a message dedicated to carrying the paging auxiliary information, or a message specifically designed to carry the paging auxiliary information.

In some embodiments, sending the paging auxiliary information for a UE in an inactive state to the core network device includes sending the paging auxiliary information to the core network device after receiving a reporting indication sent by the core network device.

The access network device sends the paging auxiliary information to the core network device only when the access network device receives the reporting indication, so unnecessary reporting by the access network device can be reduced.

In yet another embodiment, the access network device may send the paging auxiliary information to the core network device based on a pre agreed protocol.

The core network device may utilize any message sent to the access network device to carry the reporting indication, thereby triggering the access network device to return the paging auxiliary information to the core network device after receiving the reporting indication.

For example, the reporting indication is carried by at least one of:
an initial context setup request message;
a UE context modification request message;
a handover request message; or
a path switch request acknowledge message.

In an embodiment of the present disclosure, the initial context setup request is used for requesting a context of the UE. The UE context modification request is used for modifying a context of the UE.

The handover request message is used for switching a resident cell of the UE.

For the path switch request acknowledge message, after the UE switches the access network device, the core network device may return the path switch request acknowledge after receiving a switching request for switching the transmission link between the UE and the core network device sent by the access network device that the UE is switched to.

The reporting indication may be carried by one or more bits. For example, the reporting indication may be carried by 1 bit, and two bit values of the 1 bit represent an indication to report and an indication not to report, respectively.

The one or more bits carrying the reporting indication may be a reserved bit of any of the above messages, or may be a reserved bit value. Part of bit values of the bit corresponding to the reserved bit value may have been used, but another part of the bit values is unused (i.e., reserved), and these reserved bit values may be used for carrying the reporting indication.

In some embodiments, the reporting indication may also be carried in a newly add bit of any of the above messages, so as not to take up bits corresponding to other content in the above messages.

The receiving the paging auxiliary information sent by the core network device includes at least one of receiving the paging auxiliary information assigned by the core network device, or receiving the paging auxiliary information returned by the core network device after the paging auxiliary information assigned by the access network device is received by the core network device.

For example, the paging auxiliary information assigned by the core network device may include paging auxiliary information assigned by the core network device for the UE in the idle state. For example, the paging auxiliary information may at least include paging group information, for the paging group of the UE in the idle state, indicative of the paging group for the UE in the idle state to transmit a paging message.

For example, if the core network device also assigns paging auxiliary information for the UE in the inactive state, the paging auxiliary information received by the access network device from the core network device may further include paging auxiliary information, for the UE in the inactive state, assigned by the core network device.

In some embodiments, the paging auxiliary information for the UE in the inactive state may be assigned by the access network device itself. The access network device, after assigning the paging auxiliary information for the UE in the inactive state, may report the paging auxiliary information to the core network device. Subsequently, if the access network device loses its own assigned paging auxiliary information for the UE in the inactive state, the access network device may request it from the core network device. Alternatively, the core network device sends the paging auxiliary information to the access network device upon detecting that a particular downlink event is met.

In some embodiments, receiving the paging auxiliary information sent by the core network device includes receiving the paging auxiliary information carried by a paging instruction. The paging instruction is an indication sent by the core network device for paging the UE.

In order to reduce unnecessary message interactions between the core network device and the access network device, the paging auxiliary information sent by the core network device to the access network device may be carried in the paging instruction. The paging instruction at least carries a paging identification indicating the UE to be paged by the core network device. After receiving the paging instruction, the access network device may send to the UE indicated by the paging identification carried in the paging instruction. In an embodiment of the present disclosure, the paging instruction also carries the paging auxiliary information, and the paging auxiliary information may be at least used for the access network device to determine a paging group for sending the paging message. After determining the paging group, the access network device may send the paging message for paging the UE in the corresponding paging group of a PO instead of sending the paging message in all paging groups of the entire PO, so as to reduce the unnecessary sending of the paging message. At the same time, the UE may also send the paging message only in the corresponding paging group, which also reduces the number of paging groups that the UE needs to monitor and reduces the power consumption of the UE.

The paging auxiliary information carried by the paging instruction may be paging auxiliary information for the UE in the inactive state and/or paging auxiliary information for the UE in the idle state. The paging auxiliary information may include paging group information indicative of a paging group and/or paging period information indicative of a paging period.

In some embodiments, after the UE enters the inactive state, the access network device may report the auxiliary information for paging the UE in the inactive state to the core network device. In this way, the core network device may be aware of the UE entering into the inactive state. Of course, the access network device may also report to the core network device the indication information that the UE has entered into the inactive state. In this way, the core network device may also know that the UE has entered into the inactive state.

For example, the paging group information is carried in a paging instruction of the core network device for paging the UE. The paging auxiliary information carried in the paging instruction (CN paging) by the core network device at this point may include auxiliary information for paging the UE in the idle state and/or auxiliary information for paging the UE in the inactive state.

For example, the paging instruction of the core network device for paging the UE carries both the auxiliary information for paging the UE in the inactive state and the auxiliary information for paging the UE in the idle state. Alternatively, the paging instruction of the core network device for paging the UE carries the auxiliary information for paging the UE in the idle state.

For example, if the core network device determines that the UE is in the idle state, the paging instruction of the core network device for paging the UE may separately carry the auxiliary information for paging the UE in the idle state. For example, if the core network device determines that the UE is in the inactive state, the paging instruction of the core network device for paging the UE at least carries the auxiliary information for paging the UE in the inactive state. For example, if the core network device determines that the UE is in the inactive state and an anomaly has occurred, such as the access network device having lost a context and the core network device having been notified, the paging instruction of the core network device for paging the UE at least carries the auxiliary information for paging the UE in the inactive state. In this way, after the second auxiliary information is received by the access network device, the access network device may send, based on the auxiliary information for paging the UE in the inactive state, a paging message, in the paging group corresponding to the inactive state in the PO, triggered by the paging instruction of the core network device for paging the UE. One possible implementation for the core network device is that if the core network device determines that the UE is in the idle state, the paging instruction of the core network device for paging the UE may separately carry the auxiliary information for paging the UE in the idle state; and when the core network device determines that the UE is in the inactive state, the paging instruction of the core network device for paging UE at least carries the auxiliary information for paging the UE in the inactive state. Subsequently, when the UE enters the idle state again, the paging instruction of the core network device for paging the UE may again separately carry the auxiliary information for paging the UE in the idle state, i.e., a fallback is performed.

The paging instruction of the core network device for paging the UE includes the paging instruction of the core network device for paging the UE separately carrying the auxiliary information for paging the UE in the inactive state, or the paging instruction of the core network device for paging the UE carrying both the auxiliary information for paging the UE in the inactive state and the auxiliary information for paging the UE in the idle state.

In some embodiments, an information processing method performed by the access network device may include one of:
receiving a paging instruction from the core network device, where the paging instruction carries auxiliary information for paging an inactive state UE; and sending a paging message to the UE in the paging group indicated by the auxiliary information for paging the idle state UE in the idle state PO; where the idle state PO is the PO for paging the UE in the idle state, i.e., the idle state PO is the first type PO, which may be calculated and determined from the paging period carried in the auxiliary information for paging the UE in the inactive state;
sending, when a paging instruction from the core network device is not received, a paging message to an inactive state UE in the paging group corresponding to the paging group information for the inactive state UE in the inactive state PO (i.e., in the second type PO); herein, the inactive state PO is the second type PO; the inactive state PO is the PO for paging the UE in the inactive state, which may be calculated and determined from the paging period carried in the auxiliary information for paging the UE in the inactive state; or
receiving a paging instruction from the core network device, where the paging instruction carries auxiliary information for paging an inactive state UE; and sending a paging message to the UE in the paging group indicated by the auxiliary information for paging the inactive state UE in the inactive state PO; herein, the inactive state PO is the PO for paging the UE in the inactive state, i.e., the inactive state PO is the second type PO, which may be calculated and determined from the paging period carried in the auxiliary information for paging the UE in the inactive state.

The above methods may be used in combination, for example, the paging instruction of the core network device for paging the UE carries both the auxiliary information for paging the UE in the inactive state and the auxiliary information for paging the UE in the idle state. The access network device sends the paging message according to the two kinds of auxiliary information at the same time.

In the event that the paging group information for the inactive state is not obtained when the UE in the inactive state needs to be paged, the paging message for paging the UE in the inactive state is sent in any paging group in the PO for the UE in the inactive state.

In the event that both the state information of the UE and the paging group information are lost, the paging message for paging the UE in the inactive state is sent in any paging group in all POs; all POs herein may include the first type PO and the second type PO.

Of course, the above is only an example for illustration of paging based on the paging group information, and the specific implementation is not limited to the above example.

Through the above methods, even when the UE is in the inactive state, the UE may monitor, based on the paging auxiliary information, the paging information in the paging group corresponding to the inactive state, and the UE may monitor the CN paging initiated by the access network device for the UE based on the paging instruction sent by the core network device.

In another embodiment, the information processing method performed by the access network device may include: if the paging group information for the inactive state is not obtained when the UE in the inactive state needs to be paged, sending, in the first type PO for the UE, the paging message for paging the UE in the paging group corresponding to the idle state. In this condition, if the UE in the inactive state needs to monitor the CN paging, it is necessary to monitor, in the first type PO based on the paging auxiliary information for the UE in the idle state, the paging message in the paging group corresponding to the idle state, and it is also necessary to monitor, in the second type PO based on the paging auxiliary information for the UE in the inactive state, the paging message in the paging group corresponding to the UE in the inactive state.

In some embodiments, the method further includes sending to the core network device the paging group information indicative of a paging group for the UE in the inactive state to transmit a paging message, and the paging group information indicative of a paging group for the UE in the inactive state to transmit a paging message is assigned by the RAN.

If the access network device assigns the paging group information indicative of a paging group for the UE in the inactive state to transmit a paging message, the access network device may request the paging group information from the core network device due to consideration that the paging group information may be used by the core network device, or in case of the access network device losing the paging group information. At this time, even if the paging group information indicative of a paging group for the UE in the inactive state to transmit a paging message does not involve the CN paging, the RAN may report the paging group information, indicative of a paging group for the UE in the inactive state to transmit a paging message, assigned by the RAN itself to the core network device.

In some embodiments, an information processing method performed by the access network device may include at least one of the following:
obtaining the paging group information indicative of a paging group for the UE in the idle state to transmit a paging message, and sending a paging message for paging the UE in the first type PO based on the paging group information indicative of the paging group for the UE in the idle state to transmit a paging message;
obtaining the paging group information indicative of a paging group for the UE in the inactive state to transmit a paging message, sending a paging message for paging the UE in the second type PO based on the paging group information indicative of the paging group for the UE in the inactive state to transmit a paging message;
not obtaining the paging group information indicative of a paging group for the UE in the inactive state to transmit a paging message, sending a paging message for paging the UE in any paging group in the first type PO; or
receiving from the core network device the paging instruction for paging the UE in the inactive state, sending a paging message for paging the UE based on the acquisition of the paging group information indicative of a paging group for the UE in the inactive state to transmit a paging message.

There is an overlapping part of the first type PO and the second type PO in the time domain, or they may not overlap in the time domain.

The first type PO and the second type PO may be obtained by calculating based on the paging period indicated by the auxiliary information for paging the UE in the inactive state and the paging period indicated by the auxiliary information for paging the UE in the idle state, respectively.

As an embodiment, the first type PO is the PO corresponding to the CN paging period. The second type PO is the PO corresponding to the RAN paging period or the PO corresponding to the default paging period.

For example, if the {CN paging period, RAN paging period, default paging period} configured in the inactive state of the UE are {60, 10, 20}, the first type PO is the PO corresponding to the CN paging period, i.e., it repeats periodically with a 60 ms period corresponding to 0 ms, 60 m, 120 ms . . . and the second type PO is the PO corresponding to the RAN paging period, i.e., it repeats periodically with a 10 ms period corresponding to 0 ms, 10 m, 20 ms . . . ; at this time, there is an overlapping part of the first type PO and the second type PO in the time domain.

As an embodiment, the first type PO is the PO corresponding to the CN paging period; the second type PO is the PO corresponding to the default paging period.

For example, if the {CN paging period, RAN paging period, default paging period} configured in the inactive state of the UE are {60, 20, 10}, the first type PO is the PO corresponding to the CN paging period, i.e., it repeats periodically with a 60 ms period corresponding to 0 ms, 60 m, 120 ms . . . and the second type PO is the PO corresponding to the default paging period, i.e., it repeats periodically with a 10 ms period corresponding to Oms, 10 m, 20 ms . . . ; at this time, there is an overlapping part of the first type PO and the second type PO in the time domain.

As an embodiment, the first type PO is a specific PO selected in accordance with a pattern among all POs, and the second type PO is all POs. Herein, the specific PO is a part of all the POs. At this time, the pattern of the specific PO may be notified to the UE by the network side in advance or determined based on the protocol.

All POs herein may include all of the POs determined from the CN paging period, RAN paging period, and default paging period.

For example, if the {CN paging period, RAN paging period, default paging period} are configured in the inactive state of the UE, at this time, the UE may monitor paging with a paging period of 10 ms, i.e., all the POs monitored by the UE repeats periodically with a 10 ms period corresponding to 0 ms, 10 m, 20 ms . . . . Assuming that the first type PO may be selected at every interval of a 20 ms period, at this time, the first type PO repeats periodically with a 20 ms period corresponding to 0 ms, 20 m, 40 ms . . . and at this time, all POs of the second type repeats periodically with a 10 ms period corresponding to 0 ms, 10 m, 20 ms . . . .

As an embodiment, the first type PO is a specific PO selected in accordance with a pattern among all POs, and the second type PO is the remaining PO. At this time, the first type PO and the second type PO may not overlap in the time domain.

Sending the paging message, for paging the UE in the inactive state, based on the acquisition of the paging group information indicative of a paging group for the UE in the inactive state to transmit a paging message includes at least one of:
receiving from the core network device the paging instruction for paging the UE in the inactive state and obtaining the paging group information, sending, in the second type PO, the paging message for paging the UE in the inactive state based on the paging group information indicative of the paging group for the UE in the inactive state to transmit the paging message;
receiving from the core network device the paging instruction for paging the UE in the idle state and not obtaining the paging group information, sending, in the first type PO, the paging message based on the paging group information indicative of the paging group for the UE in the idle state to transmit the paging message.

The above methods may be used in combination, for example, the paging instruction of the core network device for paging the UE carries both the auxiliary information for paging the UE in the inactive state and the auxiliary information for paging the UE in the idle state. The access network device sends the paging message according to the two kinds of auxiliary information at the same time.

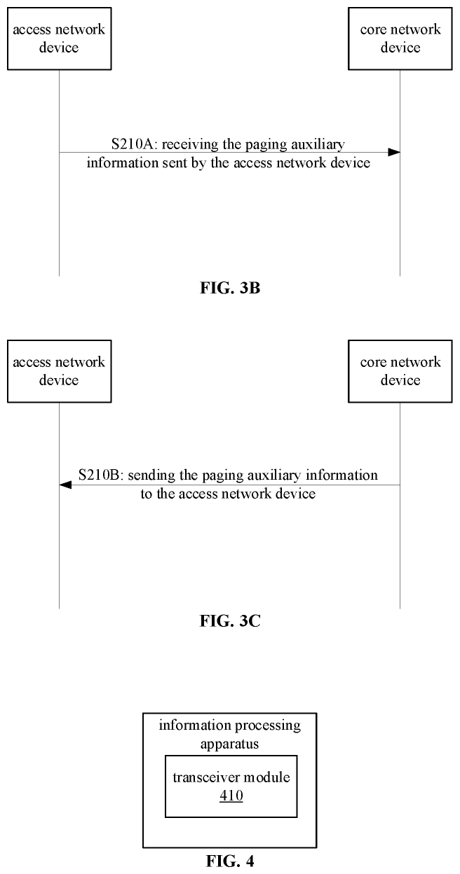

As shown in FIGS. 3A to 3C, an embodiment of the present disclosure provides an information processing method. The method is performed by a core network device, and includes the following step S210.

At step S210, transmission of paging auxiliary information for paging a UE is performed between the core network device and an access network device. The paging auxiliary information is used for paging the UE.

The information processing method provided by the embodiments of the present disclosure may be applied in a network element of the core network device. The network element of the core network device includes, but is not limited to, an AMF.

In an embodiment of the present disclosure, the network element of the core network device may interact with the access network device for the paging auxiliary information.

In an application scenario, when the terminal device is in an idle state, the network may send a paging message for the idle state device based on the idle state paging group information, and when the terminal device enters an inactive state, the network may send a paging message for the inactive state terminal device based on the inactive state paging group information. However, in the inactive state, because the state stored by the network and the actual state of the terminal may not be consistent, i.e., the network thinks that the terminal device is in the idle state, i.e., the network still sends a paging message for the idle state terminal device based on the idle state paging group information; and the terminal device is still in the inactive state, and may monitor the paging message that is sent by the network for the inactive state terminal device based on the inactive state paging group information (i.e., the terminal is not aware of the occurrence of the anomaly). That is, when the terminal device is in the inactive state, it needs to monitor both the paging message sent by the network for the idle state terminal device based on the idle state paging group information and the paging message sent by the network for the inactive state terminal device based on the inactive state paging group information. The embodiments of the present disclosure provide a mechanism for the core network device to interact with the access network device for the paging auxiliary information, which enables the inactivate state UE to monitor in the inactivate state the paging group information sent by the network for the idle state terminal device and/or and the paging group information sent by the network for the inactivate state terminal device, so as not to miss in an abnormal situation the paging message of the network.

For example, as shown in FIG. 3B and FIG. 3C, the step S210 may include at least one of step S210A or step S210B.

At step S210A, the paging auxiliary information sent by the access network device is received by the core network device.

At step S210B, the paging auxiliary information is sent by the core network device to the access network device.

The paging auxiliary information received by the core network device from the access network device may include paging auxiliary information assigned by the access network device itself. The paging auxiliary information assigned by the access network device herein may include paging auxiliary information for a UE in the inactive state and/or paging auxiliary information for a UE in the idle state.

In some embodiments, the paging auxiliary information sent to the access network device may include paging auxiliary information assigned by the core network device, and/or paging auxiliary information received from the access network device.

The paging auxiliary information assigned by the core network device may include at least one of paging auxiliary information assigned by the core network device for the UE in the idle state, or paging auxiliary information assigned by the core network device for the UE in the inactive state.

It is therefore understood that sending the paging auxiliary information to the access network device includes:
sending to the access network device the paging auxiliary information assigned by the core network device; and/or
sending, based on the paging auxiliary information received from the access network device, the paging auxiliary information to the access network device.

In some embodiments, the paging auxiliary information includes at least one of auxiliary information for paging the UE in the inactive state, or auxiliary information for paging the UE in the idle state.

For example, the paging auxiliary information includes at least one of:
paging group information assigned for the UE in the inactive state, where the paging group information is used for a paging group in which the UE monitors a paging message; or
paging period information assigned for the UE in the inactive state, where the paging period information is at least used for indicating a paging frame for the UE in the inactive state to monitor the paging message.

It is understood that the paging group information includes at least one of:
a group identification, used for indicating a paging group in which the UE is located;
a paging probability value, where the paging probability value corresponds to a paging group; or
a paging probability level, where the paging probability level corresponds to a paging group.

In some embodiments, the paging group information includes at least one of:
paging group information indicative of a paging group for the UE in the idle state to transmit a paging message; or
paging group information indicative of a paging group for the UE in the inactive state to transmit a paging message.

It is understood that receiving the paging auxiliary information, for paging the UE, sent by the access network device includes at least one of:
receiving a radio connection control inactive state transition request message carrying the paging auxiliary information;
receiving an initial context setup response message carrying the paging auxiliary information;
receiving a UE context modification response message carrying the paging auxiliary information;
receiving a UE context modification indication message carrying the paging auxiliary information;
receiving a context suspend request message carrying the paging auxiliary information;
receiving a retrieve UE information message carrying the paging auxiliary information;
receiving a handover request acknowledge message carrying the paging auxiliary information; sending the paging auxiliary information to the core network device;
sending the paging auxiliary information to the core network device via a path switch request message; or
receiving a dedicated message carrying the paging auxiliary information.

The paging auxiliary message reported by the access network device may carry an existing message in the related arts or a newly added dedicated message.

In some embodiments, the method includes sending a reporting indication. The reporting indication is used for indicating the access network device to report the paging auxiliary information.

This reporting indication is used for indicating the access network device to report the paging auxiliary information. For example, this reporting indication is used for indicating the access network device to report the paging auxiliary information assigned by the access network device itself.

In some embodiments, the reporting indication is carried by at least one of:
an initial context setup request message;
a UE context modification request message;
a handover request message; or
a path switch request acknowledge message.

There are many ways in which the core network device sends the reporting indication to the access network device. For example, the reporting indication may be carried in any of the above messages.

In some embodiments, sending the paging auxiliary information to the access network device includes: sending, when a paging instruction for paging the UE is sent to the access network device, the paging instruction carrying the paging auxiliary information to the access network device.

In the embodiments of the present disclosure, when the core network device notifies the access network device to page the UE, the paging instruction carrying the paging auxiliary information is sent to the access network device. Therefore, when the access network device receives the paging instruction sent by the core network device, the access network device may page the UE in a targeted manner according to the paging auxiliary information. In particular, the paging auxiliary information carried by the paging instruction may at least include the paging auxiliary information for the UE in the inactive state. Therefore, after the access network device receives the paging auxiliary information, since the access network device receives the paging auxiliary information from the core network device, even if the UE currently paged by the core network device is not in the idle state, and the core network device pages the UE due to an abnormal situation such as a context abnormality, the UE in the inactive state can be paged according to the paging auxiliary information for the UE in the inactive state, and the UE in the inactive state can be paged in the PO of the UE in the inactive state and in the corresponding paging group, thereby realizing targeted paging for the UE by the access network device on the one hand, and increasing the paging success rate of the UE on the other hand.

In some embodiments, the paging group information is carried in the paging instruction of the core network device for paging the UE.

For example, the paging instruction of the core network device for paging the UE carries both auxiliary information for paging the UE in the inactive state and auxiliary information for paging the UE in the idle state; or, the paging instruction of the core network device for paging the UE carries the auxiliary information for paging the UE in the inactive state.

Normally, the core network device does not know whether the UE is currently in the inactive state. When the access network device reports the second auxiliary information for the UE in the inactive state to the core network device, the core network device may determine that the UE has entered the inactive state. Alternatively, after receiving from the access network device the indication indicating that the UE has entered the inactive state, the core network device may determine that the UE has entered the inactive state.

If the core network device needs to page the UE in the inactive state, at least the auxiliary information for paging the UE in the inactive state may be carried in the paging instruction, so that the access network device can send, based on the auxiliary information for paging the UE in the inactive state, a paging message in the paging group monitored by the UE in the inactive state.

The embodiments of the present disclosure provide a solution for handling paging monitoring by paging the UE according to the paging group of the UE during paging when the access network device and core network device maintain inconsistent terminal states.

For example, the paging auxiliary information for the UE in the inactive state sent by the access network device to the core network device is used for the core network device to send the paging message for the UE. The paging auxiliary information may include the paging group information.

The paging group information assigned by the access network device for the UE is used for the terminal to determine the group where it monitors when monitoring paging signals.

As an embodiment, the paging group information provided or assigned by the network may be a specific assigned group identification (group ID).

As an embodiment, the paging group information provided or assigned by the network is a paging probability value determined by the network.

As an embodiment, the paging group information provided or assigned by the network is a paging probability indication determined by the network. The paging probability indication may include a paging probability level and/or a paging probability interval.

The paging period information assigned by the access network device for the UE is used for the terminal to determine the paging frame where it monitors when monitoring paging signals.

The paging group information may be notified to the core network device in the following information. The paging group information serves as a type of information contained in the paging auxiliary information.

As an embodiment, the access network device may carry the auxiliary information in the existing RRC inactive transaction report message.

As an embodiment, the access network device may carry the paging auxiliary information based on a newly added message.

As an implementation, the access network device sends the paging auxiliary information for the UE in the inactive state to the core network device. As another implementation, the core network device configures the paging auxiliary information for the UE in the inactive state, and sends the paging auxiliary information to the access network device. If the access network device itself configures the paging auxiliary information for the UE in the inactive state, the access network device may refer to the paging auxiliary information configured by the core network device for the UE in the idle state to determine the paging auxiliary information for the UE in the inactive state. The paging group information included in the paging auxiliary information for the UE in the inactive state and the paging group information configured by the core network device for the idle state may point to the same paging group. Of course, in other embodiments, the paging group information for the inactive state and idle state of the same UE may point to different paging groups.

As an embodiment, the core network device may carry the indication in one of the following messages to indicate whether the access network device can report or stop reporting the auxiliary information:
initial context setup request message;
UE context modification request message;
handover request message; or
path switch request acknowledge message.

If the reporting indication is the first value, it indicates that the access network device is indicated to report the paging auxiliary information to the core network device. If the reporting indication is the second value, it indicates that the access network device is indicated to stop reporting the paging auxiliary information to the core network device or not report the paging auxiliary information to the core network device.

If the access network device supports the reporting of the auxiliary information, the access network device may report the auxiliary information.

In some embodiments, the core network device may carry one of the following types of information in the paging message initiated to the UE:
paging group information assigned by the access network devices for the UE; or
paging period information assigned by the access network device for the UE, where the paging period information is used for the terminal to determine the paging frame where it monitors when monitoring paging signals.

As shown in FIG. 4, an embodiment of the present disclosure provides an information processing apparatus. The apparatus includes a transceiver module 410.

The transceiver module 410 is configured to perform, between an access network device and a core network device, transmission of paging auxiliary information for paging a UE. The paging auxiliary information is used for paging the UE.

For example, the apparatus may be applied in the access network device.

In some embodiments, the transceiver module 410 may include a program module. The program module, when executed by a processor, enables the transmission of the paging auxiliary information for paging a UE between the access network device and the core network device.

In some embodiments, the paging auxiliary information may at least include paging auxiliary information for a UE in an inactive state.

In still other embodiments, the transceiver module 410 may include a hardware/software combination module. The hardware/software combination module includes, but is not limited to, a variety of programmable arrays. The programmable arrays include, but are not limited to, field programmable arrays and/or complex programmable arrays.

In still other embodiments, the transceiver module 410 includes, but is not limited to, a hardware-only module. The hardware-only module includes, but is not limited to, a specialized integrated circuit.

In some embodiments, the transceiver module 410, is configured to perform at least one of:
send to the core network device the paging auxiliary information assigned by an access network device; or
receive the paging auxiliary information sent by the core network device.

In some embodiments, the paging auxiliary information includes at least one of:
auxiliary information for paging a UE in an inactive state; or
auxiliary information for paging a UE in an idle state.

In some embodiments, the paging auxiliary information includes at least one of:
paging group information assigned for the UE in the inactive state, where the paging group information is used for a paging group in which the UE monitors a paging message; or
paging period information assigned for the UE in the inactive state, where the paging period information is at least used for indicating a paging frame for the UE in the inactive state to monitor the paging message.

In some embodiments, the paging group information includes at least one of:
a group identification, used for indicating a paging group in which the UE is located;
a paging probability value, wherein the paging probability value corresponds to a paging group; or
a paging probability level, wherein the paging probability level corresponds to a paging group.

In some embodiments, the paging group information includes at least one of:
paging group information indicative of a paging group for a UE in an idle state to transmit a paging message; or
paging group information indicative of a paging group for the UE in the inactive state to transmit a paging message.

In some embodiments, the transceiver module 410 is specifically configured to perform at least one of:
send the paging auxiliary information to the core network device via a radio connection control inactive state transition request message;
send the paging auxiliary information to the core network device via an initial context setup response message;
send the paging auxiliary information to the core network device via a UE context modification response message;
send the paging auxiliary information to the core network device via a UE context modification indication message;
send the paging auxiliary information to the core network device via a context suspend request message;
send the paging auxiliary information to the core network device via a retrieve UE information message;
send the paging auxiliary information to the core network device via a handover request acknowledge message;
send the paging auxiliary information to the core network device via a path switch request message; or
send the paging auxiliary information to the core network device via a dedicated message.

In some embodiments, the transceiver module 410 is specifically configured to send the paging auxiliary information to the core network device after receiving a reporting indication sent by the core network device.

In some embodiments, the reporting indication is carried by at least one of:
an initial context setup request message;
a UE context modification request message;
a handover request message; or
a path switch request acknowledge message.

In some embodiments, the transceiver module 410 is specifically configured to perform at least one of:
receive the paging auxiliary information assigned by the core network device; or
receive the paging auxiliary information returned by the core network device after the paging auxiliary information assigned by the access network device is received by the core network device.

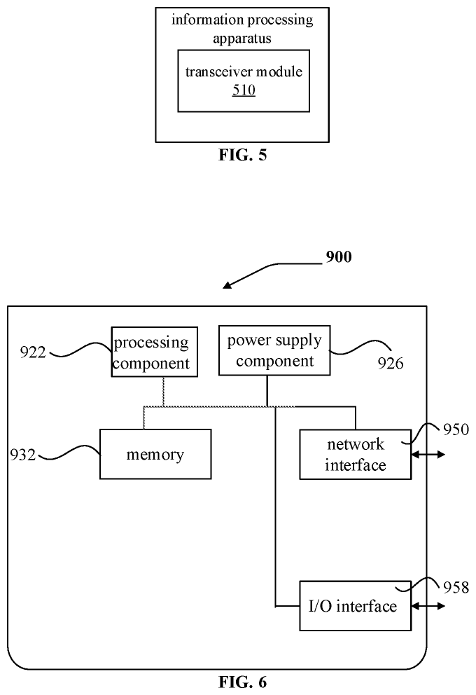

As shown in FIG. 5, an embodiment of the present disclosure provides an information processing apparatus. The apparatus includes a transceiver module 510.

The transceiver module 510 is configured to perform, between a core network device and an access network device, transmission of paging auxiliary information for paging a UE. The paging auxiliary information is used for paging the UE.

For example, the apparatus may be applied in the core network device. The core network device includes, but is not limited to, an AMF.

In some embodiments, the transceiver module 510 may include a program module. The program module, when executed by a processor, enables the transmission of the paging auxiliary information for paging a UE between the access network device and the core network device.

In some embodiments, the paging auxiliary information may at least include paging auxiliary information for a UE in an inactive state.

In still other embodiments, the transceiver module 510 may include a hardware/software combination module. The hardware/software combination module includes, but is not limited to, a variety of programmable arrays. The programmable arrays include, but are not limited to, field programmable arrays and/or complex programmable arrays.

In still other embodiments, the transceiver module 510 includes, but is not limited to, a hardware-only module. The hardware-only module includes, but is not limited to, a specialized integrated circuit.

In some embodiments, the transceiver module 510 is specifically configured to receive the paging auxiliary information sent by the access network device, and/or send the paging auxiliary information to the access network device.

In some embodiments, the transceiver module 510 is specifically configured to send to the access network device the paging auxiliary information assigned by a core network device, and/or send, based on the paging auxiliary information received from the access network device, the paging auxiliary information to the access network device.

In some embodiments, the paging auxiliary information includes at least one of:
auxiliary information for paging a UE in an inactive state; or
auxiliary information for paging a UE in an idle state.

In some embodiments, the paging auxiliary information includes at least one of:
paging group information assigned for the UE in the inactive state, where the paging group information is used for a paging group in which the UE monitors a paging message; or
paging period information assigned for the UE in the inactive state, where the paging period information is at least used for indicating a paging frame for the UE in the inactive state to monitor the paging message.

In some embodiments, the paging group information includes at least one of:
a group identification, used for indicating a paging group in which the UE is located;
a paging probability value, where the paging probability value corresponds to a paging group; or
a paging probability level, where the paging probability level corresponds to a paging group.

In some embodiments, the paging group information includes at least one of:
paging group information indicative of a paging group for the UE in the idle state to transmit a paging group; or
paging group information indicative of a paging group for the UE in the inactive state to transmit a paging group.

In some embodiments, receiving the paging auxiliary information, for paging the UE, sent by the access network device includes at least one of:
receiving a radio connection control inactive state transition request message carrying the paging auxiliary information;
receiving an initial context setup response message carrying the paging auxiliary information;
receiving a UE context modification response message carrying the paging auxiliary information;
receiving a UE context modification indication message carrying the paging auxiliary information;
receiving a context suspend request message carrying the paging auxiliary information;
receiving a retrieve UE information message carrying the paging auxiliary information;
receiving a handover request acknowledge message carrying the paging auxiliary information; sending the paging auxiliary information to the core network device;
sending the paging auxiliary information to the core network device via a path switch request message; or
receiving a dedicated message carrying the paging auxiliary information.

In some embodiments, the transceiver module 510 is further configured to send a reporting indication. The reporting indication is used for indicating the access network device to report the paging auxiliary information.

In some embodiments, the reporting indication is carried by at least one of:
an initial context setup request message;
a UE context modification request message;
a handover request message; or
a path switch request acknowledge message.

In some embodiments, the paging group information is carried in the paging instruction of the core network device for paging the UE.

In some embodiments, the paging instruction of the core network device for paging the UE carries both auxiliary information for paging the UE in the inactive state and auxiliary information for paging the UE in the idle state; or the paging instruction of the core network device for paging the UE carries the auxiliary information for paging the UE in the inactive state.

An embodiment of the present disclosure provides a communication device. The communication device includes a memory configured to store an executable instruction executable by a processor, and a processor connected to the memory.

The processor is configured to execute the information processing method provided by any of the foregoing technical solutions. The information processing method may be an information processing method executed by the access network device, and/or an information processing method executed by a network element of the core network device.

The processor may include various types of storage media. The storage media are non-transitory computer storage media capable of continuing to memorize the information stored therein after the communication device is powered down.

Herein, the communication device includes an access device, a UE or a core network device.

The processor may be connected to the memory via a bus or the like for reading the executable program stored in the memory, e.g., at least one of the information processing methods as shown in FIGS. 2A to 2C, 3A to 3C.

As shown in FIG. 6, an embodiment of the present disclosure illustrates a structure of a communication device. For example, the communication device 900 may be provided as a network side device. The communication device may be the aforementioned access network device and/or network element of the core network device.

Referring to FIG. 6, the communication device 900 includes a processing component 922, which further includes one or more processors, and memory resources represented by a memory 932 for storing instructions, such as an application program, that may be executed by the processing component 922. The application program stored in the memory 932 may include one or more modules each corresponding to a set of instructions. In addition, the processing component 922 is used for executing the instructions to perform any of the methods applied to the communication device described above, for example, at least one of the information processing methods shown in FIGS. 2A to 2C, and FIGS. 3A to 3C.

The communication device 900 may also include a power supply component 926 for performing power management of the communication device 900, a wired or wireless network interface 950 for connecting the communication device 900 to the network, and an input/output (I/O) interface 958. The communication device 900 may operate an operating system stored in the memory 932, such as Windows Server™, Mac OS X™, Unix™, Linux™, FreeBSD™ or the like.

In the technical solutions provided by the embodiments of the present disclosure, the access network device and the core network device may interact with the paging auxiliary information used for paging the UE. In this way, regardless of whether the paging auxiliary information is assigned by the core network device or the access network device, through such mutual transmission between the access network device and the core network device, when the access network device sends a paging message to the UE, it is possible to enable the access network device to send the paging message to the UE in a targeted manner according to the paging auxiliary information, thereby increasing the paging success rate of the UE and reducing the sending of unnecessary paging messages.

The present disclosure aims to cover any variations, uses, or adaptive changes of the present invention, which follow the general principles of the present disclosure and include common knowledge or commonly used technical means in the technical field that are not disclosed in the present disclosure. The specification and embodiments are only considered exemplary, and the true scope and spirit of the present disclosure are indicated by the following claims.

It should be understood that the present disclosure is not limited to the precise structure described above and shown in the accompanying drawings, and various modifications and changes can be made without departing from the scope of the present disclosure. The scope of the present disclosure is limited only by the accompanying claims.

1. An information processing method, comprising:
transmitting, by an access network device and between the access network device and a core network device, paging auxiliary information for paging a user equipment (UE).

2. The method according to claim 1, wherein transmitting the paging auxiliary information for paging the UE comprises at least one of:
sending to the core network device the paging auxiliary information assigned by the access network device; or
receiving the paging auxiliary information sent by the core network device.

3. The method according to claim 1, wherein the paging auxiliary information comprises at least one of:
auxiliary information for paging a UE in an inactive state; or
auxiliary information for paging a UE in an idle state.

4. The method according to claim 1, wherein the paging auxiliary information comprises at least one of:
paging group information assigned for the UE, wherein the paging group information is configured to indicate a paging group in which the UE monitors a paging message; or
paging period information assigned for the UE, wherein the paging period information is at least configured to indicate a paging frame for the UE to monitor the paging message.

5. The method according to claim 4, wherein the paging group information comprises at least one of:
a group identification, configured to indicate a paging group in which the UE is located;
a paging probability value, wherein the paging probability value corresponds to a paging group; or
a paging probability level, wherein the paging probability level corresponds to a paging group.

6. The method according to claim 4, wherein the paging group information comprises at least one of:
paging group information indicative of a paging group for the UE in an idle state to transmit a paging message; or
paging group information indicative of a paging group for the UE in an inactive state to transmit a paging message.

7. The method according to claim 1, wherein transmitting the paging auxiliary information for paging the UE comprises at least one of:
sending the paging auxiliary information to the core network device via a radio connection control inactive state transition request message;
sending the paging auxiliary information to the core network device via an initial context setup response message;
sending the paging auxiliary information to the core network device via a UE context modification response message;
sending the paging auxiliary information to the core network device via a UE context modification indication message;
sending the paging auxiliary information to the core network device via a context suspend request message;
sending the paging auxiliary information to the core network device via a retrieve UE information message;
sending the paging auxiliary information to the core network device via a handover request acknowledge message;
sending the paging auxiliary information to the core network device via a path switch request message; or
sending the paging auxiliary information to the core network device via a dedicated message.

8. The method according to claim 1, wherein transmitting the paging auxiliary information for paging the UE comprises at least one of:
sending the paging auxiliary information to the core network device in response to receiving a reporting indication sent by the core network device;
wherein the reporting indication is carried by at least one of:
an initial context setup request message;
a UE context modification request message;
a handover request message; or
a path switch request acknowledge message.

9. (canceled)

10. The method according to claim 2, wherein receiving the paging auxiliary information sent by the core network device comprises at least one of:
receiving the paging auxiliary information assigned by the core network device; or
receiving the paging auxiliary information returned by the core network device after the paging auxiliary information assigned by the access network device is received by the core network device.

11. An information processing method, comprising:
transmitting, by a core network device and between the core network device and an access network device, paging auxiliary information for paging a user equipment (UE).

12. The method according to claim 11, wherein transmitting the paging auxiliary information for paging the UE comprises at least one of:
receiving the paging auxiliary information sent by the access network device; or
sending the paging auxiliary information to the access network device.

13. The method according to claim 12, wherein sending the paging auxiliary information to the access network device comprises at least one of:
sending to the access network device the paging auxiliary information assigned by the core network device; or
in response to receiving the paging auxiliary information from the access network device sending the paging auxiliary information to the access network device.

14. The method according to claim 11, wherein the paging auxiliary information comprises at least one of:
auxiliary information for paging a UE in an inactive state; or
auxiliary information for paging a UE in an idle state.

15. The method according to claim 11, wherein the paging auxiliary information comprises at least one of:
paging group information assigned for the UE, wherein the paging group information is configured to indicate a paging group in which the UE monitors a paging message; or
paging period information assigned for the UE, wherein the paging period information is at least configured to indicate a paging frame for the UE to monitor the paging message.

16. The method according to claim 15, wherein the paging group information comprises at least one of:
a group identification, configured to indicate a paging group in which the UE is located;
a paging probability value, wherein the paging probability value corresponds to a paging group; or
a paging probability level, wherein the paging probability level corresponds to a paging group.

17. The method according to claim 15, wherein the paging group information comprises at least one of:
paging group information indicative of a paging group for a UE in an idle state to transmit a paging message; or
paging group information indicative of a paging group for a UE in an inactive state to transmit a paging message.

18. The method according to claim 15, wherein the paging group information is carried in a paging instruction of the core network device for paging the UE;
wherein the paging instruction carries paging group information indicative of a paging group for a UE in an idle state to transmit a paging message, and paging group information indicative of a paging group for a UE in an inactive state to transmit a paging message; or
the paging instruction carries the paging group information indicative of the paging group for the UE in the inactive state to transmit the paging message.

19. (canceled)

20. The method according to claim 13, wherein receiving the paging auxiliary information from the access network device comprises at least one of:
receiving a radio connection control inactive state transition request message carrying the paging auxiliary information;
receiving an initial context setup response message carrying the paging auxiliary information;
receiving a UE context modification response message carrying the paging auxiliary information;
receiving a UE context modification indication message carrying the paging auxiliary information;
receiving a context suspend request message carrying the paging auxiliary information;
receiving a retrieve UE information message carrying the paging auxiliary information;
receiving a handover request acknowledge message carrying the paging auxiliary information;
receiving a path switch request message carrying the paging auxiliary information; or
receiving a dedicated message carrying the paging auxiliary information.

21-44. (canceled)

45. A communication device, comprising a processor, a transceiver, a memory, and an executable program stored in the memory and capable of being executed by the processor, wherein the processor, through executing the executable program, is configured to:
transmit, with a core network device, paging auxiliary information for paging a user equipment (UE).

46. (canceled)

47. A communication device, comprising a processor, a transceiver, a memory, and an executable program stored in the memory and capable of being executed by the processor, wherein the processor, through executing the executable program, performs the method according to claim 11.
